(19) United States
(12) Patent Application Publication
(10) Pub. No.: US 2025/0334723 A1
(43) Pub. Date: Oct. 30, 2025

(54) LENS

(71) Applicant: SAMSUNG ELECTRO-MECHANICS CO., LTD., Suwon-si (KR)

(72) Inventors: Kwang Su KIM, Suwon-si (KR); Joung Hun KIM, Suwon-si (KR); Na Yi KANG, Suwon-si (KR); Yong Suk KIM, Suwon-si (KR); Jae Hyoung GIL, Suwon-si (KR); Tae Kyung LEE, Suwon-si (KR)

(73) Assignee: SAMSUNG ELECTRO-MECHANICS CO., LTD., Suwon-si (KR)

(21) Appl. No.: 19/056,009

(22) Filed: Feb. 18, 2025

(30) Foreign Application Priority Data
Apr. 26, 2024 (KR) 10-2024-0056043
Sep. 25, 2024 (KR) 10-2024-0129756

(51) Int. Cl. G02B 3/08; G02B 1/115; G02B 1/18

(52) U.S. Cl. CPC G02B 3/08; G02B 1/115; G02B 1/18

(57) ABSTRACT

A lens includes a lens portion having a protruding pattern formed on a surface thereof including a plurality of protrusions and grooves, and a water-repellent layer disposed on the surface of the lens portion, wherein, when an average area of the grooves per 1 mm² on the surface of the lens is referred to as a space area ratio, the space area ratio is 20% or more.

### CROSS-REFERENCE TO RELATED APPLICATIONS

This application claims the benefit under 35 USC 119(a) of Korean Patent Application Nos. 10-2024-0056043 filed on Apr. 26, 2024, and 10-2024-0129756 filed on Sep. 25, 2024, in the Korean Intellectual Property Office, the entire disclosures of which are incorporated herein by reference for all purposes.

### BACKGROUND

### 1. Field

The present disclosure relates to a lens.

### 2. Description of the Background

The phenomenon of wetting or dewetting on a surface is a technology that may not only be applied to IT and electric fields, but also to the field of cosmetics, and as such, it has come to prominence.

This technology may be used in various fields that require super-hydrophobic properties that repel water droplets, super-hydrophilic properties that form a thin film without forming water droplets, and self-cleaning properties that shake off foreign matter.

Here, the amount of water droplets that may be accommodated on the surface is determined based on a contact angle, and if the contact angle is greater than 90°, the surface is considered to have water-repellent properties, and if the contact angle is less than 90°, the surface is considered to have hydrophilic properties.

In order to be applicable to various products, coating agents for water-repellent coatings have been commercialized, and these water-repellent coating agents may be organic and may be connected by their own bonding energy within the main structures of C—O, C—H, C—C, and C—F.

However, when exposed to UV rays for an extended period of time, the C—O structure and C—C structure, which have energies lower than or similar to the inherent energy of the UV wavelength, become disconnected and lose their original water-repellent coating properties.

Accordingly, in products equipped with multiple cameras in the electric and IT fields, a superhydrophobic state of lenses has to be maintained for a long period of time even in a wetting environment and reliability has to be maintained so that there is no discomfort to the user's eyes, so various coating agents have been developed to meet these needs.

Meanwhile, products, such as electric devices of vehicles, have to maintain the superhydrophobic properties and self-cleaning function of camera lenses for a long period of time, even in environments, such as fog or rain, to secure drivers' vision and safety.

Therefore, a technical solution for camera lenses for electric devices of vehicles maintaining the superhydrophobic and superhydrophobic properties of the lenses for a long period of time even in UV exposure situations may be desired.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens includes a lens portion having a protruding pattern formed on a surface thereof including a plurality of protrusions and grooves, and a water-repellent layer disposed on the surface of the lens portion, wherein, when an average area of the grooves, per 1 mm² on the surface of the lens is referred to as a space area ratio, the space area ratio is 20% or more.

A height of the protrusions in the lens portion may be 2 μm or more.

In the lens portion, when a length of a major axis of a protrusion of the plurality of protrusions is a first length and a length between longest portions of a groove of the plurality of grooves is a second length, a difference between the first length and the second length may be 20 μm or more.

The protrusions may be formed to have a polygonal or circular shape.

The lens may further include an adhesive layer disposed between the lens portion and the water-repellent layer.

The lens may further include an anti-reflective (AR) coating portion disposed between the lens portion and the water-repellent layer.

The lens may further include an adhesive layer disposed between the AR coating portion and the water-repellent layer.

The AR coating portion may include at least one material layer selected from the group consisting of siloxane, SiO₂, SiON, Si₃N₄, TiO₂, TiON, and TiN.

The AR coating portion may include a multilayer structure in which first and second layers having different refractive indices are alternately stacked one or more times.

Other features and aspects will be apparent from the following detailed description, the drawings, and the claims.

### BRIEF DESCRIPTION OF DRAWINGS

FIG. 1 is a process diagram schematically illustrating a patterning process using a PR mask method.

FIG. 2 is a process diagram schematically illustrating a patterning process using a metal hard mask method.

FIG. 3 is a photograph illustrating a portion of a lens portion having a protruding pattern formed on one surface by micropatterning.

FIGS. 4 to 7 are plan views illustrating various shapes of a protruding pattern according to one or more example embodiments of the present disclosure.

FIG. 8 is a cross-sectional view schematically illustrating a lens according to an example embodiment of the present disclosure.

FIG. 9 is a cross-sectional view schematically illustrating a lens according to another example embodiment of the present disclosure.

FIGS. 10 to 14 are graphs illustrating changes in contact angles according to the areas of grooves when depths of the grooves are different.

FIG. 15 is a graph illustrating transmittance according to a value of W-S.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide a lens implementing superhydrophobicity.

In order to manufacture a lens of the present disclosure, first, a lens portion having a protruding pattern is formed by micropatterning the glass serving as a base of the lens.

In an example embodiment, a photoresist (PR) or a metal hard mask may be applied to form a protruding pattern on the glass by micropatterning.

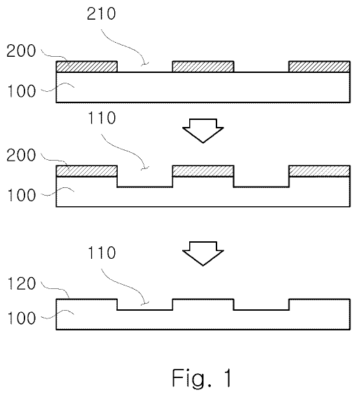

FIG. 1 roughly illustrates a patterning process using a PR mask method. As illustrated in FIG. 1, patterning using a PR mask is performed in the order of disposing PR 200 with openings 210 on glass 100, forming a groove 110 in a surface of the glass 100 by dry or wet etching, forming a plurality of protrusions 120, and then removing the PR 200.

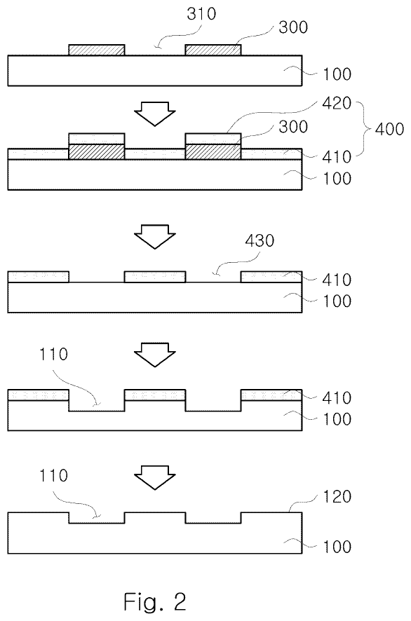

FIG. 2 is a diagram schematically illustrating a patterning process using a metal hard mask method. Referring to FIG. 2, patterning using a metal hard mask is performed in the order of disposing PR 300 with openings 310 on the glass 100, depositing a metal hard mask 400 thereon, peeling off the PR 300 and a portion 420 of the metal hard mask 400 deposited on the PR 300 together, performing dry or wet etching with a metal layer 410, the remaining portion of the metal hard mask 400 with openings 430, left, to form the groove 110 on the surface of the glass 100 to form the plurality of protrusions 120, and then, removing the metal layer 410.

Here, the metal hard mask may be formed of a material including chromium (Cr), nickel (Ni), titanium (Ti), copper (Cu), tungsten W, aluminum (Al), or at least one thereof.

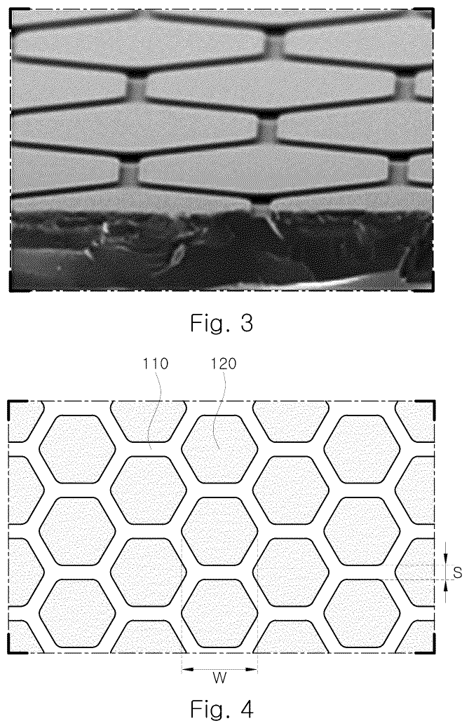

FIG. 3 is a photograph illustrating a portion of a lens portion in which a protruding pattern is formed on one surface by micropatterning.

In addition, the protruding pattern formed by micropatterning may have various shapes.

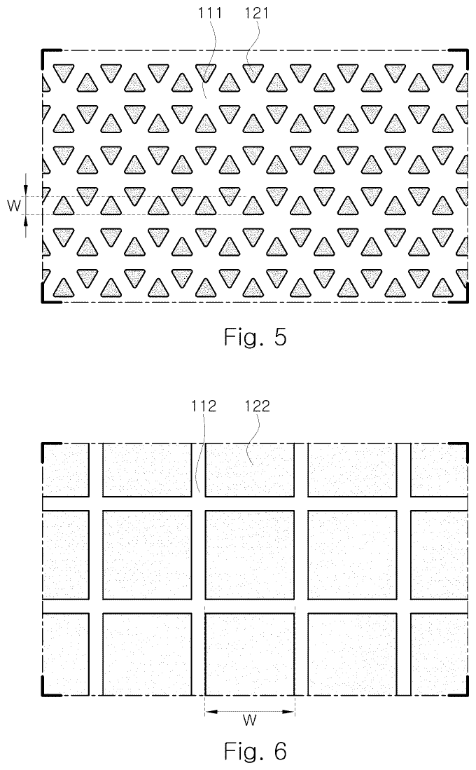

For example, each protrusion of the protruding pattern may be formed in a hexagon as in FIG. 4, in a triangle as in FIG. 5, in a square as in FIG. 6, or in a circle as in FIG. 7, but the present disclosure is not limited thereto.

In FIGS. 5 to 7, reference numerals 111, 112, and 113 denote grooves, reference numerals 121, 122, and 123 denote protrusions, S represents the width of the grooves, indicating a space between sides of adjacent protrusions, and W represents the length of a major axis of the protrusion, indicating the largest width of the protrusion.

Here, the length W of the major axis of the protrusion may be 40 μm or more. Also, the depth of the groove may be 2 μm or more.

Next, a water-repellent coating agent is applied to one surface of the lens portion 100 to form a water-repellent layer, thereby completing the lens.

Here, the surface on which the water-repellent layer is formed is a surface on which light is incident, and the water-repellent coating agent may be a polymer-based material.

The water-repellent layer may be formed by coating the water-repellent coating agent on one surface of the lens portion using an E-beam and thermal deposition process.

Here, the water-repellent coating agent may include perfluoropolyether (PFPE), polytetrafluoroethylene (PTFE), fluorinated ethylene propylene (FEP), perfluoroalkyl vinyl ether copolymer (PFA), polyvinyl fluoride (PVF), etc. including fluorine polymers.

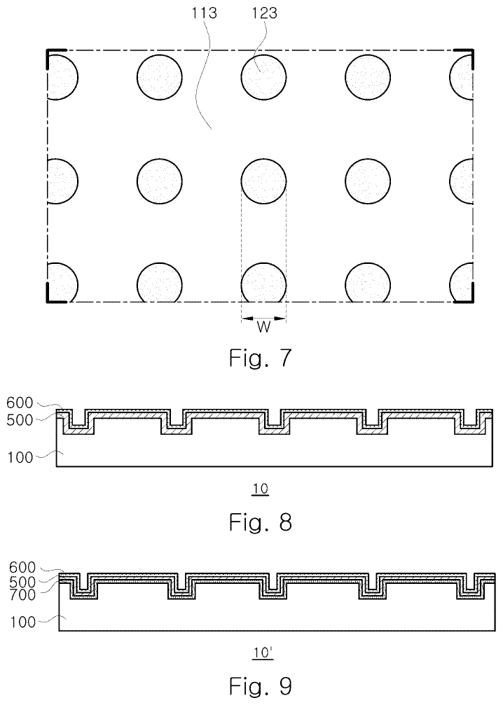

FIG. 8 is a cross-sectional view schematically illustrating a lens according to an example embodiment in the present disclosure.

Referring to FIGS. 8 and 4, a lens 10 according to an example embodiment includes a lens portion 100 and a water-repellent layer 600.

The lens portion 100 is not particularly limited in shape or type and may be implemented in a lens shape that may be used in an optical device, such as a camera module.

In addition, the lens portion 100 may be formed of glass. However, the lens portion 100 may be formed of other materials, and may be formed of, for example, a plastic resin including a resin component.

For example, the plastic resin may include at least one component among polycarbonate and polyolefin.

Here, polyolefin may include at least one among cycloolefin polymer and cycloolefin copolymer.

In an example embodiment, the lens portion 100 has a protruding pattern having a plurality of protrusions 120 and grooves 110 formed on a surface thereof. Here, the grooves 110 refer to a gap between the protrusions 120, i.e., a space.

The water-repellent layer 600 is disposed on one surface of the lens portion 100.

Also, as illustrated in FIG. 4, when the average area of the grooves 110, i.e., a portion without protrusions 120 per 1 mm² on the surface of the lens portion 100, is referred to as a space area ratio (%), the space area ratio may be set to be 20% or more in an example embodiment.

Here, the average area of the grooves 110 is obtained by generating an image of the surface of the lens portion 100 using SEM or TEM and excluding the portion in which the protrusions 120 exist. Such an image of the space area ratio, the length of the major axis of the protrusion, and the length between the longest portions of the groove, etc. described below are measured using image analysis software.

In this manner, when the space area ratio is 20% or more, an initial contact angle of the lens portion 100 may be implemented to be greater than 130°.

In addition, the height of each protrusion 120 in the lens portion 100 may be 2 μm or more.

In addition, when the length of the longest major axis among the widths of the protrusion 120 in the lens portion 100 is referred to as a first length W and the length between the longest portions of the groove 110 is referred to as a second length S, a difference (W-S) between the first length and the second length may be 20 μm or more.

When the difference between the first length and the second length is 20 μm or more, the lens 10 may secure transmittance close to that of bare glass.

Here, the value of the difference (W-S) may be obtained by measuring 10 or more values and using an average value thereof.

Meanwhile, the values, such as thickness and length in the lens portion 100, may be measured using both non-destructive and destructive testing.

Examples of non-destructive testing include methods using an ellipsometer, a reflectometer, and an atomic force microscope.

As an example of destructive analysis, the lens portion 100 may be subjected to focused ion beam (FIB) cross-section processing and then analyzed using a transmission electron microscope (TEM), and the components may also be analyzed using EDS analysis. In addition, analysis may be performed using FT-IR, XPS, etc.

The cross-section of the protrusion 120 may be taken to include the central portion of the lens portion 110, that is, the thickest region of the lens portion 110.

In addition, the thickness of the protrusion 120 may be defined as a distance measured in a direction, perpendicular to the surface and may be determined as an average value of values measured in a plurality of equally spaced regions.

In addition, the lens 10 may include an adhesive layer 500 to prevent the water-repellent layer 600 disposed on one surface of the lens portion 100 from being peeled off.

The adhesive layer 500 may be formed of a material including one or more of SiO₂, ZrO₂, MgF₂, Si₃N₄, Al₂O₃, and CeO₂.

The adhesive layer 500 may be formed by applying a process, such as sputtering, evaporation, or chemical vapor deposition (CVD).

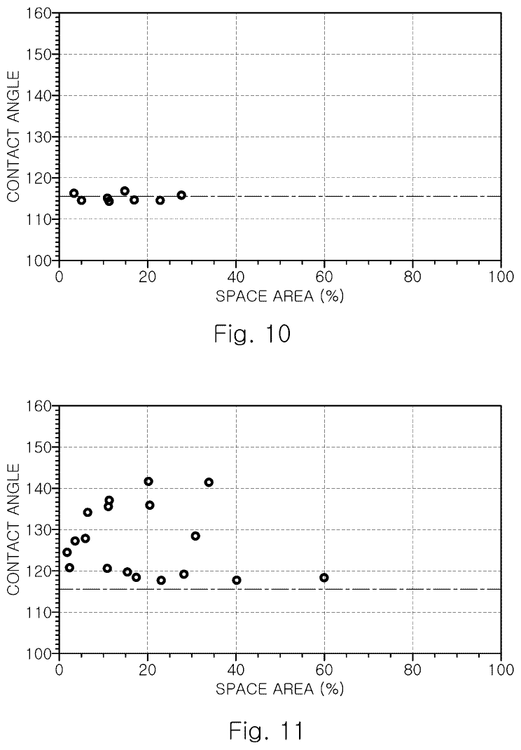

FIG. 9 is a cross-sectional view schematically illustrating a lens according to another example embodiment in the present disclosure.

Referring to FIG. 9, a lens 10′ of another example embodiment may further include an anti-reflective (AR) coating portion 700 disposed between the lens portion 100 and the water-repellent layer 600.

Here, the adhesive layer 500 is disposed between the AR coating portion 700 and the water-repellent layer 600.

The AR coating portion 700 reduces the reflectivity of the lens 100, and thus a flare phenomenon may be reduced or prevented.

In addition, the AR coating portion 700 may include at least one material layer selected from the group consisting of siloxane, SiO₂, SiON, Si₃N₄, TiO₂, TiON, or TiN.

As another example, the AR coating portion 700 may include a multilayer structure in which first and second layers having different refractive indices are alternately stacked one or more times.

In addition, the AR coating portion 700 may have a stack structure in which the first layer is a SiO₂ layer and the second layer is a TiO₂ layer.

Such an AR coating portion 700 may be formed by coating one surface of the lens portion through an E-beam process using an E-beam evaporator facility with a thermal device.

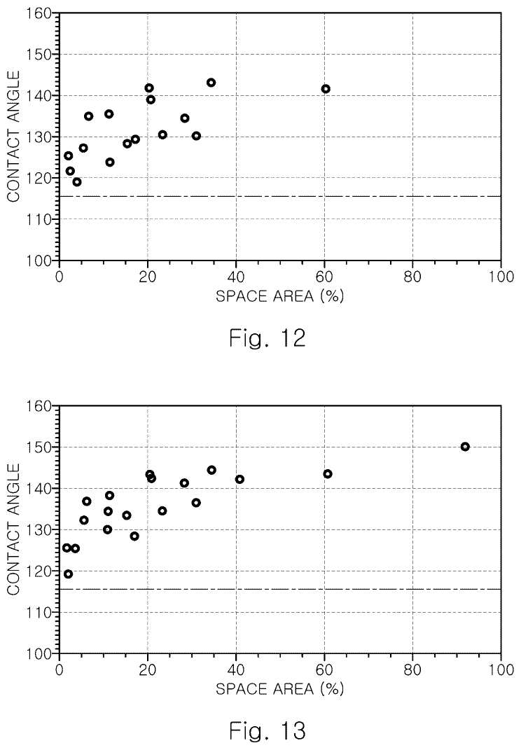

FIGS. 10 to 14 are graphs illustrating changes in contact angle of the lens according to the space area ratio when the depths of the grooves are different.

FIG. 10 illustrates that an average depth of the groove is 0.5 μm, and here, it can be seen that the contact angle is about 115° when the space area ratio is 40% or less.

FIG. 11 illustrates that the average depth of the groove was 1.0 μm, and here, the contact angle was 115° or more, up to 140°.

FIG. 12 illustrates that the average depth of the groove was 2.0 μm, and here, the contact angle was 115° or more, and when the space area ratio was 20% or more, the contact angle was 130° or more.

FIG. 13 illustrates that the average depth of the groove was 3.0 μm, and here, the contact angle was 115° or more, and when the space area ratio was 20% or more, the contact angle was 130° or more.

FIG. 14 illustrates that the average depth of the groove was 4.0 μm, and here, the contact angle was 120° or more, and when the space area ratio was 20% or more, the contact angle was 130° or more.

Referring to FIGS. 10 to 14, the correlation between the space area ratio (%) per unit area and the initial contact angle of the lens according to the depth of the groove (etched depth) is as follows.

When the depth of the groove is less than 2 μm, the correlation between the space area ratio (%) and the contact angle is not proportional.

However, when the depth of the groove is 2 μm, the space area ratio and the contact angle show a proportional relationship.

In addition, when the depth of the groove exceeds 2 μm, the space area ratio (%) and the contact angle show an almost insignificant value, so it can be seen that the contact angle when the depth of the groove is deeper than 2 μm and the space area ratio (%) is 20% or more is greater than 130°.

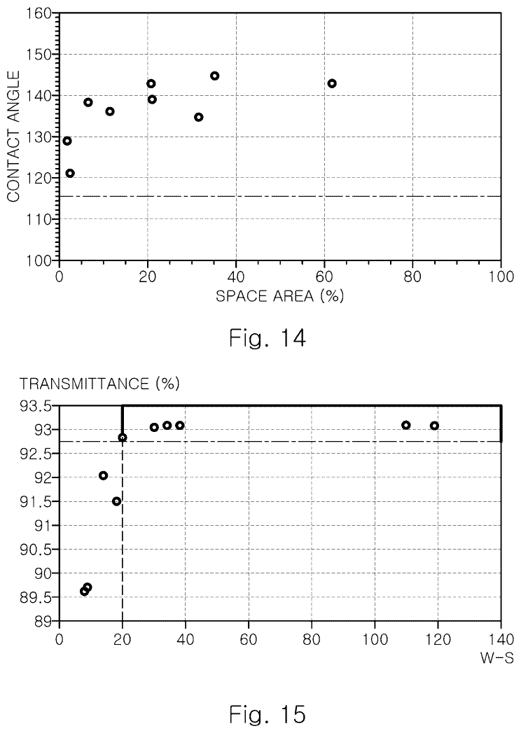

FIG. 15 is a graph illustrating transmittance of the lens according to the value of the difference (W-S) between the length of the major axis of the protrusion and the length between the longest portions of the groove in the lens having the structure of FIG. 8 of the present disclosure.

Referring to FIG. 15, it can be seen that the transmittance under the conditions in which the difference between the length of the major axis of the protrusion and the length between the longest portions of the groove is 20 μm or more is close to the transmittance of bare glass. The simulation tool used here is the result reflecting RSOFT (SYNOPSYS®) and LIGHTTOOLS (SYNOPSYS®).

The lens configured in this manner may be applied to camera modules for electric devices of vehicles or camera modules for portable electronic devices, such as smartphones, tablets, PCs, and laptops for IT.

In particular, since a vision may be stably secured even in wet conditions through a camera lens for electric devices of vehicles, safe driving may be secured when applied to fields, such as autonomous driving.

In the case of a flat lens (hereinafter referred to as a ‘comparative example’) in which a water-repellent coating layer is formed by simply applying a water-repellent coating agent to the surface of the related art lens, it may be difficult to make the initial contact angle greater than 120°.

In addition, in the case of the comparative example, as a result of the UV reliability evaluation, it can be seen that the contact angle of the lens continues to decrease over time, and after 1,500 hours, the contact angle of the lens decreases below 90°, indicating that the water repellency is not maintained for a long period of time.

Meanwhile, in an example embodiment, a water repellent coating layer is formed by applying the water repellent coating agent to the surface of the lens portion, and the surface of the lens portion is configured to have a protruding pattern having a plurality of protrusions, so that the initial contact angle of the lens may be obtained close to 140°.

Here, by obtaining the space area ratio of 20% or more, the contact angle of the lens may be maintained to be greater than 130° even after 1,750 hours, and thus it may be confirmed that the lens has superhydrophobicity.

In the case of the lens according to an example embodiment of the present disclosure, the micro-patterned protruding pattern may be formed on the surface and the water repellent layer is formed thereon, so that the lens may be implemented to have superhydrophobicity.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens comprising:
a lens portion having a protruding pattern formed on a surface thereof including a plurality of protrusions and grooves; and
a water-repellent layer disposed on the surface of the lens portion,
wherein, when an average area of the grooves per 1 mm² on the surface of the lens is referred to as a space area ratio, the space area ratio is 20% or more.

2. The lens of claim 1, wherein a height of the protrusions in the lens portion is 2 μm or more.

3. The lens of claim 1, wherein, in the lens portion, when a length of a major axis of a protrusion of the plurality of protrusions is a first length and a length between longest portions of a groove of the plurality of grooves is a second length, a difference between the first length and the second length is 20 μm or more.

4. The lens of claim 1, wherein, in the lens portion, a height of the protrusions is 2 μm or more, and in the lens portion, when a length of a major axis of a protrusion of the plurality of protrusions is a first length and a length of a major axis of a groove of the plurality of grooves is a second length, a difference between the first length and the second length is 20 μm or more.

5. The lens of claim 1, wherein the protrusions are formed to have a polygonal or circular shape.

6. The lens of claim 1, further comprising an adhesive layer disposed between the lens portion and the water-repellent layer.

7. The lens of claim 1, further comprising an anti-reflective (AR) coating portion disposed between the lens portion and the water-repellent layer.

8. The lens of claim 7, further comprising an adhesive layer disposed between the AR coating portion and the water-repellent layer.

9. The lens of claim 7, wherein the AR coating portion includes at least one material layer selected from the group consisting of siloxane, SiO₂, SiON, Si₃N₄, TiO₂, TiON, and TiN.

10. The lens of claim 7, wherein the AR coating portion includes a multilayer structure in which first and second layers having different refractive indices are alternately stacked one or more times.
